(19) United States
(12) Patent Application Publication
(10) Pub. No.: US 2011/0089653 A1
(43) Pub. Date: Apr. 21, 2011

(54) TROLLEY AND A WHEEL ASSEMBLY FOR A TROLLEY

(75) Inventors: Richard Russell, Victoria (AU); Jon Graham Seddon, Victoria (AU)

(73) Assignee: Reapan Pty Limited

(21) Appl. No.: 12/674,742

(22) PCT Filed: Aug. 19, 2008
(86) PCT No.: PCT/AU08/01200

§ 371 Date: Dec. 3, 2010

(30) Foreign Application Priority Data
Aug. 23, 2007 (AU) 2007904574

(51) Int. Cl. B62B 3/02; B62B 5/04

(52) U.S. Cl. 280/47.34

(57) ABSTRACT

A trolley (10), including a trolley frame (12), a plurality of wheels (14,16), (18,20) mounted to the frame (12) for supporting the trolley (10) thereon, and a direction control wheel (22). The direction control wheel (22) is connected to the frame (12) and displaceable relative to the frame (12) between at least three positions, the at least three positions including a ground contact position, a ground clearance position and an obstacle negotiating position. The direction control wheel (22) is provided for controlling the direction of travel of the trolley (10) when in the ground contact position. The direction control wheel (22) is operably movable between the ground contact position and the ground clearance position, and independently movable between the ground contact position and the obstacle negotiating position. Further, the direction control wheel (22) is independently movable between the ground clearance position and the obstacle negotiating position.

The present invention relates broadly to a trolley and a wheel assembly. More particularly, the present invention relates to a trolley, and a wheel assembly for a trolley with improved direction control characteristics and will be herein generally described in that context.

Conventional trolleys such as, for example, shopping trolleys often do not track or move in the desired direction of travel, especially if one or more of the trolley wheels is damaged or requiring maintenance. This can be inconvenient, unmanageable and even potentially dangerous for the trolley user.

Even with adequately operating conventional trolleys, such trolleys can be difficult, unmanageable and even potentially dangerous to use on sloping surfaces such as in supermarket carparks.

Carpark gutters, kerbs and other obstacles can also be difficult if not impossible to negotiate with conventional trolleys, as the obstacle can result in one or more of the trolley wheels losing contact with the ground while negotiating the obstacle.

Various approaches to address these problems have been contemplated in the past. However, none of these have proven overly effective.

The present invention attempts to at least partially address the above mentioned deficiencies associated with existing trolleys.

According to one broad aspect of the present invention, there is provided a trolley. The trolley includes a trolley frame, a plurality of wheels mounted to the frame for supporting the trolley thereon, and a direction control wheel. The direction control wheel is connected to the frame and displaceable relative to the frame between at least three positions, the at least three positions including a ground contact position, a ground clearance position and an obstacle negotiating position. The direction control wheel is provided for controlling the direction of travel of the trolley when in the ground contact position. The direction control wheel is operably movable between the ground contact position and the ground clearance position, and independently movable between the ground contact position and the obstacle negotiating position. Further, the direction control wheel is independently movable between the ground clearance position and the obstacle negotiating position.

The term “ground” as used herein is to be understood to include any surface upon which a user may wish to use the trolley. The surface may be, for example, any indoor surface or outdoor surface.

The trolley may be of any practical form. It is envisaged that the trolley may be a shopping trolley. However, the trolley may be of any other practical form that may be used in any one or more of residential, commercial, retail and industrial applications.

The trolley is configured to provide the trolley user with the option of using the trolley with the direction control wheel in an active (or ground contact position) or in an inactive (ground clearance position). With the direction control wheel in the ground contact position the wheel guides the trolley in a desired direction or directions of travel. However, with the direction control wheel in the ground clearance position the wheel exerts substantially no influence over the direction of travel of the trolley.

In a preferred form, the orientation of the direction control wheel relative to the frame is fixed such that contact of the wheel with the ground directs any movement of the trolley in a pre-defined direction(s). More preferably, the direction control wheel, when in the ground contact position, limits the trolley to a single direction of travel and corresponding reverse direction of travel. It is envisaged that this direction may correspond to the forward direction of the trolley (and reverse direction). However, this configuration may be altered if the trolley is to be used for an application in which another fixed direction (or directions) of travel of the trolley is preferred.

The provision of a selectively operable direction control wheel may be particularly useful in respect of supermarket trolleys, which have a tendency to wander from their desired direction of travel because of damaged or poorly maintained wheels. Moreover, such an arrangement would assist the trolley user when pushing a laden trolley to their vehicle, particularly when this entails pushing the trolley across an uneven and/or sloping surface. Trolley users are presented with particular difficulty when attempting to traverse a slope with a laden trolley, as the trolley weight tends to drag the trolley down the slope due to the effects of gravity. However, with the direction control wheel in the active, ground contact position the wheel resists the tendency of the trolley roll down the hill, thereby allowing the shopper to relatively easily traverse the slope with the trolley.

One particularly useful feature of the present invention is the direction control wheel being independently movable to an obstacle negotiating position. Such an arrangement allows the direction control wheel to independently negotiate a range of obstacles that may be encountered. In this respect, the control wheel is capable of moving out of the way when it meets an obstacle, allowing the remaining wheels to stay on the ground such that the trolley stability is maintained. It is to be appreciated that the direction control wheel preferably rises to an obstacle negotiating position when a predefined upward force is applied to it, such as when contacting an obstacle.

Further, such an arrangement may be configured to potentially provide improved trolley stability in situations where one or more of the trolley wheels leave the ground, for example when the trolley is being pushed over a roadway gutter or kerb. In such a circumstance, the direction control wheel, within practical limits, remains in contact with the ground by moving to an obstacle negotiating position and may, in that position, provide trolley stability in place of the trolley wheels temporarily out of contact with the ground.

Each of the plurality of wheels may adopt any practical form. In one preferred arrangement, each of the plurality of wheels is a castor wheel. However, it is to be appreciated that other types of wheels or combinations of wheel types may be used if desired.

In one form, the direction control wheel is rotatable about a control wheel axle, with the control wheel axle being connected to a generally longitudinally extending wheel arm. In such an arrangement the control wheel axle preferably extends in an axial direction orientated generally tangentially relative to the generally longitudinally extending wheel arm.

It is envisaged that in one preferred, but non-limiting form, the arm extends in a generally fore and aft direction relative to the trolley, having a front or forward end and a rear end.

In one form, the direction control wheel is displaceable in a substantially vertical plane between each of the ground contact position, ground clearance position, and obstacle negotiating position. The direction control wheel may of course be displaceable in any other plane or indeed may be displaceable along a non-linear path between one or more of the ground contact position, ground clearance position and obstacle negotiating position.

It is to be appreciated that the ground clearance position and the obstacle negotiating position may be the same position. For example, the ground clearance position may correspond to the position(s) defined by the obstacle negotiating position.

Preferably, the wheel arm is independently pivotable relative to the frame about a first pivot axis for moving the direction control wheel between the ground contact position and obstacle negotiating position; and between the ground clearance position and the obstacle negotiating position.

Further, preferably, the wheel arm is operably pivotable relative to the frame about the first pivot axis for moving the direction control wheel between the ground contact position and ground clearance position.

The direction control wheel may be connected to the arm generally rearwardly of the first pivot axis.

In a preferred form, the wheel arm is independently pivotable relative to the frame about a first pivot axle pivotably connected to the frame and substantially co-axial with the first pivot axis.

The trolley may include a biasing means for biasing the arm (or direction control wheel) in a downward direction when the direction control wheel is in the ground contact position and when in the ground clearance position. In one non-limiting form, the biasing means includes a torsion spring mounted to the frame for biasing the arm in a downward direction when the direction control wheel is in the ground contact position and when in the ground clearance position.

The biasing means may include a deactivating mechanism for deactivating the downward bias of the biasing means on the arm (or direction control wheel) when the direction control wheel is in the obstacle negotiating position.

In one form, the deactivating mechanism includes a cam pivotally mounted to the frame, with a torsion spring biasing the cam into contact with a generally upwardly facing arm surface when the direction control wheel is in the ground contact position and when in the ground clearance position. In such an arrangement, the torsion spring may bias the cam into contact with a generally side arm surface when the direction control wheel is in the obstacle negotiating position.

The arm preferably includes a rear end portion angled relative to the longitudinally extending arm to facilitate nesting of the trolley with another trolley.

In one form, a manually actuated biasing member is provided for contacting (or otherwise engaging) the wheel arm to move the wheel arm and, in turn, move the direction control wheel from the ground contact position to the ground clearance position. The biasing member may be pivotably connected to the frame.

A manually operated actuator is preferably provided for actuating the biasing member so as to move the direction control wheel from the ground contact position to the ground clearance position. In this respect, the trolley may include a trolley handle with the actuator mounted to or proximate the trolley handle. A cable or other suitable arrangement is preferably connected between the biasing member and the actuator.

The cable may be connected to the biasing member at any suitable location, including a preferred location at a forward end of the biasing member, proximate a forward end of the wheel arm. The forward end of the biasing member is preferably vertically displaceable in response to actuation of the actuator. The cable may be routed through hollow trolley frame members between the actuator and the wheel arm for improved aesthetics, and to ensure that the cable is not exposed and therefore prone to damage.

In another possible form, the manually operated actuator may include a foot pedal or lever pivotably connected to the frame, and connected to the wheel arm by a suitably configured linkage arrangement. It is to be appreciated that the linkage may be replaced by any other suitable arrangement, such as a cable.

Further, in addition to or in place of the actuator and cable linkage arrangements described above, movement of the direction control wheel between the ground contact position and ground clearance position may be automatically undertaken. Such an arrangement may be desired in situations such as supermarket applications, where it may be preferred that the direction control wheel be automatically moved to the ground contact position when a shopper exits the supermarket with the trolley. Automatic movement of the direction control wheel to the ground contact position may be by any suitable means, including an electronic controller provided in or proximate the supermarket, which is in wireless communication with a receiver coupled to the trolley's direction control wheel. Indeed, such a controller may independently control the movement of the direction control wheel to the ground contact position for a fleet of trolleys.

The trolley may include any suitable number of wheels. In one arrangement, the trolley may include four wheels, with each wheel including a wheel mount mounted to or proximate the underside of the frame; and with the direction control wheel mounted to or proximate the underside of the frame at a location generally bounded by the four wheel mounts. In such an arrangement, the direction control wheel may be mounted to the frame at least proximate the midpoint of the wheel mounts or slightly forward of the midpoint. This configuration has been found to provide a desired level of trolley maneuverability with the direction control wheel contacting the ground. Further, this configuration has been found to provide the desired advantage that the trolley can relatively easily rotate about the direction control wheel when mounted in this position and when in contact with the ground.

In an arrangement wherein the trolley includes four wheels in addition to the direction control wheel, the direction control wheel may be mounted to the frame such that the direction control wheel is proximate the intersection point of imaginary lines drawn between the mounts of diagonally oppositely disposed wheels.

The trolley may include a brake provided on at least one of the plurality of wheels. In a particularly preferred form, the trolley includes two front wheels and two rear wheels, with a brake provided on each of the two rear wheels. The provision of two wheel brakes in combination with the direction control wheel provides a trolley capable of being left unattended and securely parked, even when left unattended on a sloping surface and irrespective of which direction the trolley may be pointing on the sloping surface.

Each of the brakes may adopt any suitable form, including a foot actuated brake.

The invention has, so far been defined in terms of the direction control wheel being movable between the ground contact and ground clearance positions and an obstacle negotiating position. More preferably, however, the direction control wheel is independently movable relative to the frame between the ground contact position and a range of obstacle negotiating positions; and likewise between the ground clearance position and a range of obstacle negotiating positions. This enables the direction control wheel, within practical limits, to negotiate obstacles having a range of dimensions.

In one form, the frame includes a sub-frame extending around a lower region of the frame, with the sub-frame including a portion extending generally rearwardly between the wheels mounts of the two front wheels, and with the arm pivotably mounted to the sub-frame portion at or proximate the generally rearwardly extending portion.

The direction control wheel has so far generally been described as a fifth trolley wheel. However, the direction control wheel may replace a conventional trolley wheel, if desired. Further, the trolley may include two or more direction control wheels, if desired.

The invention has, thus far, been generally described in terms of a trolley. However, the present invention also relates to a direction control wheel for use on a trolley, since such a direction control wheel may be integrated into a trolley or separately manufactured and subsequently retro-fitted to a trolley.

Thus, according to another broad aspect of the present invention, there is provided a direction control wheel for a trolley having a trolley frame and a plurality of wheels mounted to the frame for supporting the trolley thereon. The direction control wheel, when connected to the frame, is displaceable relative to the frame between at least three positions. The at least three positions include a ground contact position, a ground clearance position and an obstacle negotiating position. The direction control wheel is provided for controlling the direction of travel of the trolley when in the ground contact position. The direction control wheel is operably movable between the ground contact position and ground clearance position, independently movable between the ground contact position and the obstacle negotiating position, and independently movable between the ground clearance position and the obstacle negotiating position.

It is to be appreciated that if the direction control wheel is to be retrofitted then the direction control wheel may be provided in the form of an assembly, including a mount for mounting to a trolley frame.

It will be convenient to hereinafter describe a preferred embodiment of the invention with reference to the accompanying drawings. The particularity of the drawings is to be understood as not limiting the preceding broad description of the invention.

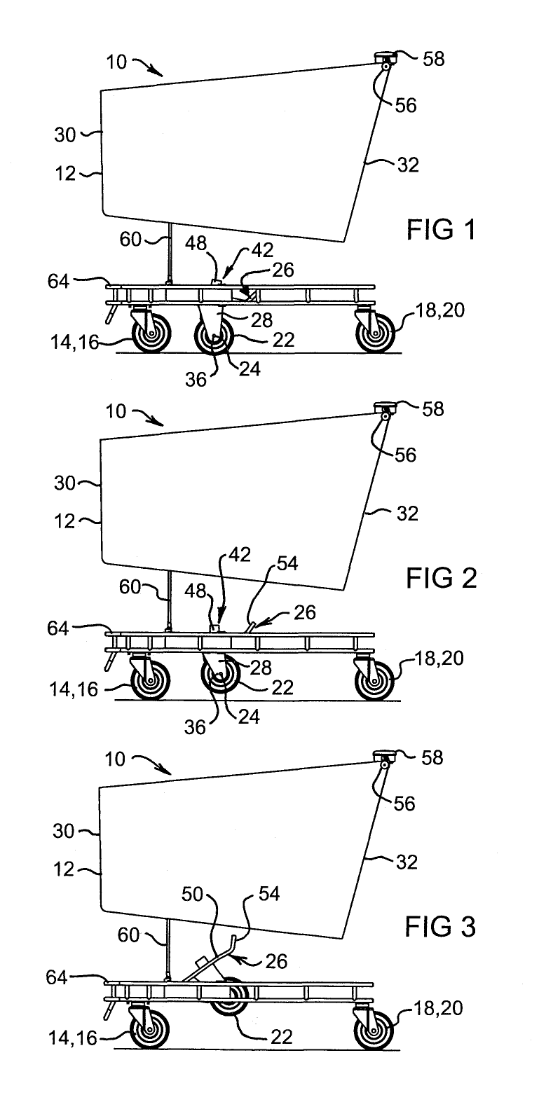

FIG. 1 is a side view of a trolley in accordance with one embodiment of the present invention, with the direction control wheel illustrated in the ground contact position.

FIG. 2 is a side view of the trolley illustrated in FIG. 1, with the direction control wheel illustrated in the ground clearance position.

FIG. 3 is a side view of the trolley illustrated in FIG. 1, with the direction control wheel illustrated an obstacle negotiating position.

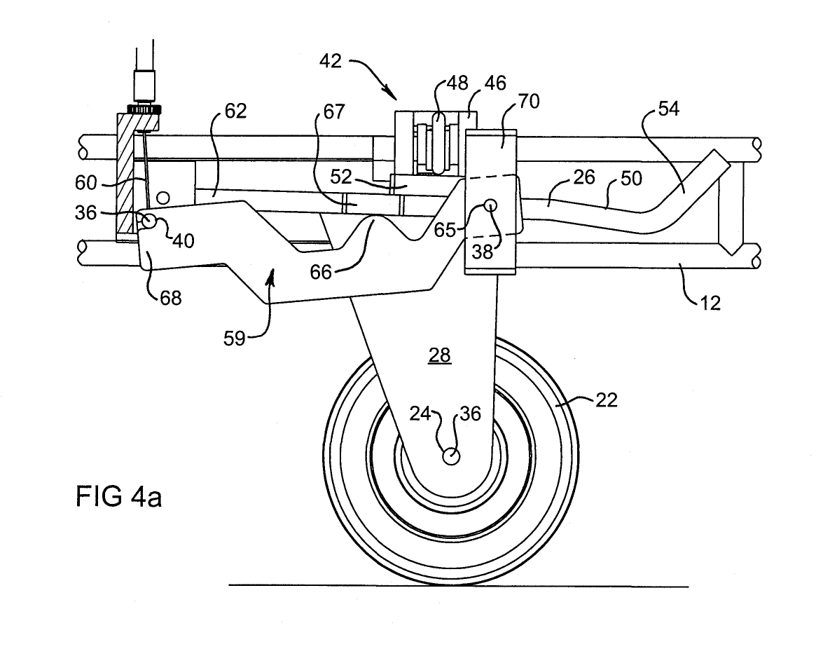

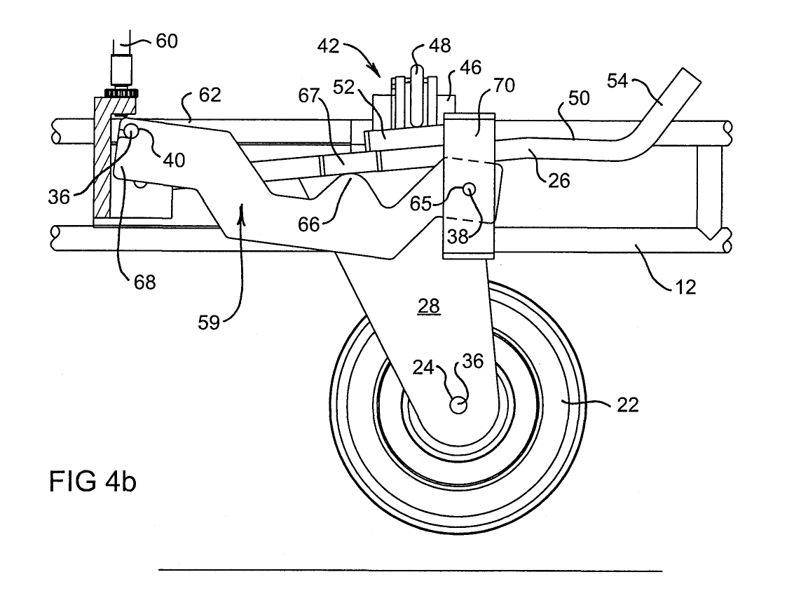

FIG. 4a is a fragmentary view of the direction control wheel of the trolley illustrated in FIG. 1 in the ground contact position.

FIG. 4b is a fragmentary view of the direction control wheel of the trolley illustrated in FIG. 1 in the ground clearance position.

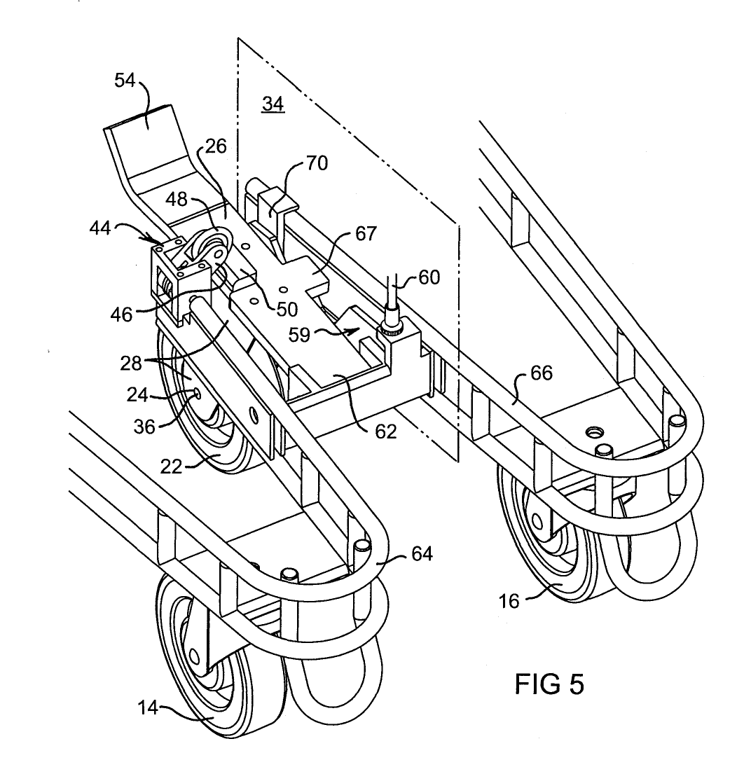

FIG. 5 is a magnified perspective view of the direction control wheel of the trolley illustrated in FIG. 1.

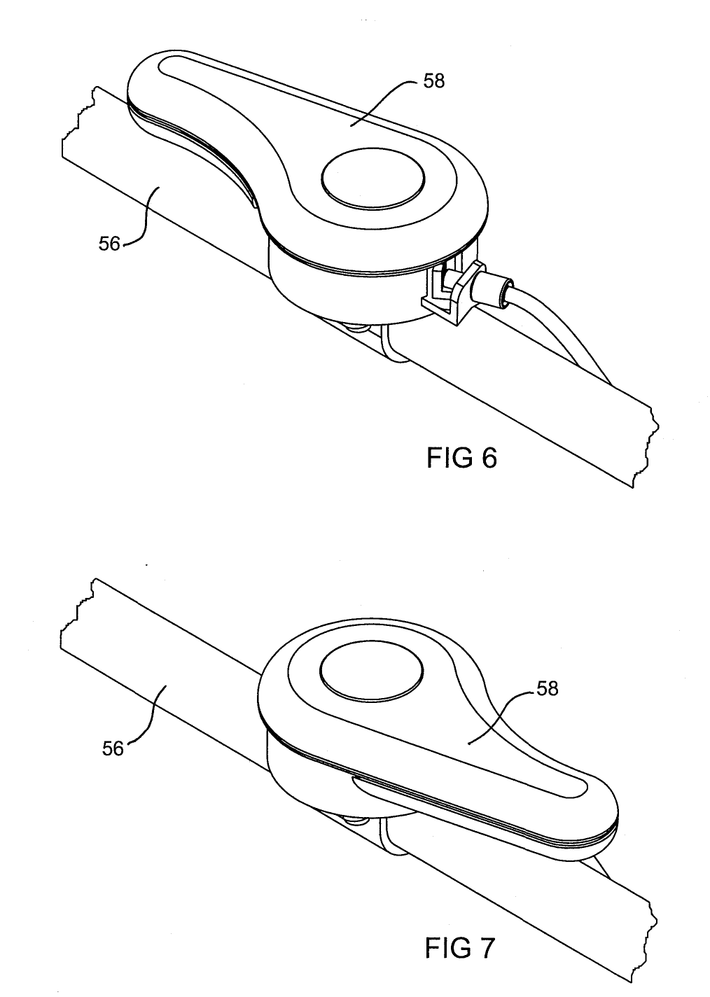

FIG. 6 is a magnified perspective view of the actuator of the trolley illustrated in FIG. 1 when adjusted such that the direction control wheel is in the ground contact position.

FIG. 7 is another magnified perspective view of the actuator of the trolley illustrated in FIG. 1 when adjusted such that the direction control wheel is in the ground clearance position.

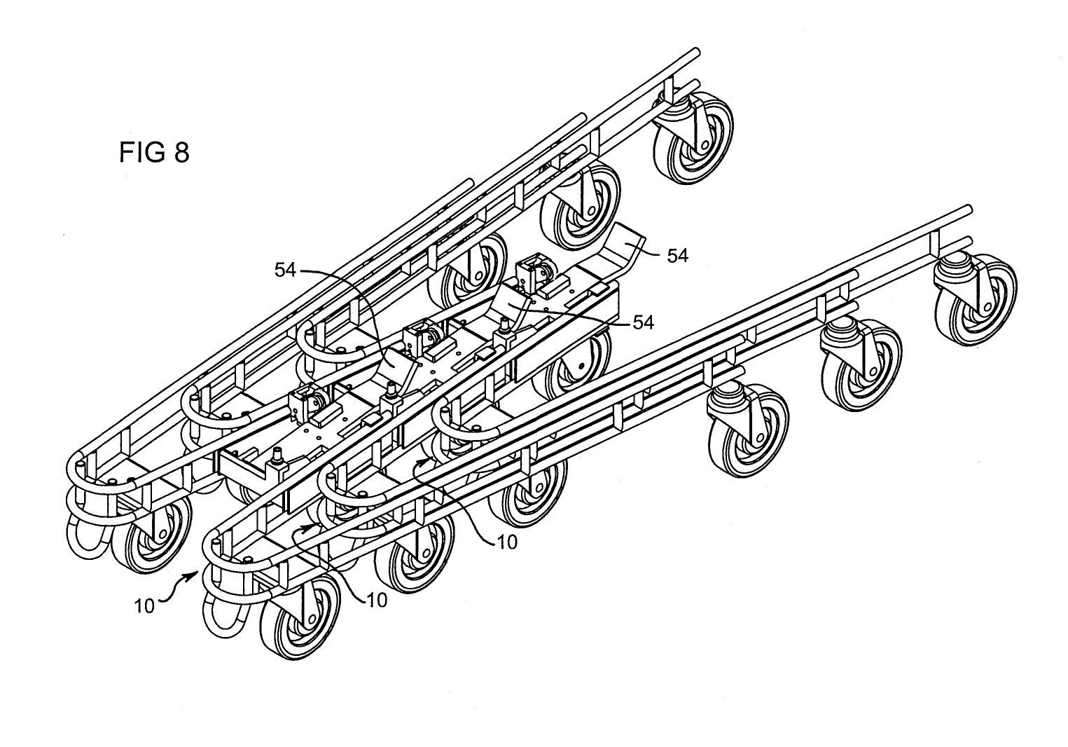

FIG. 8 is a perspective view of the trolley illustrated in FIG. 1 when nested with two like trolleys.

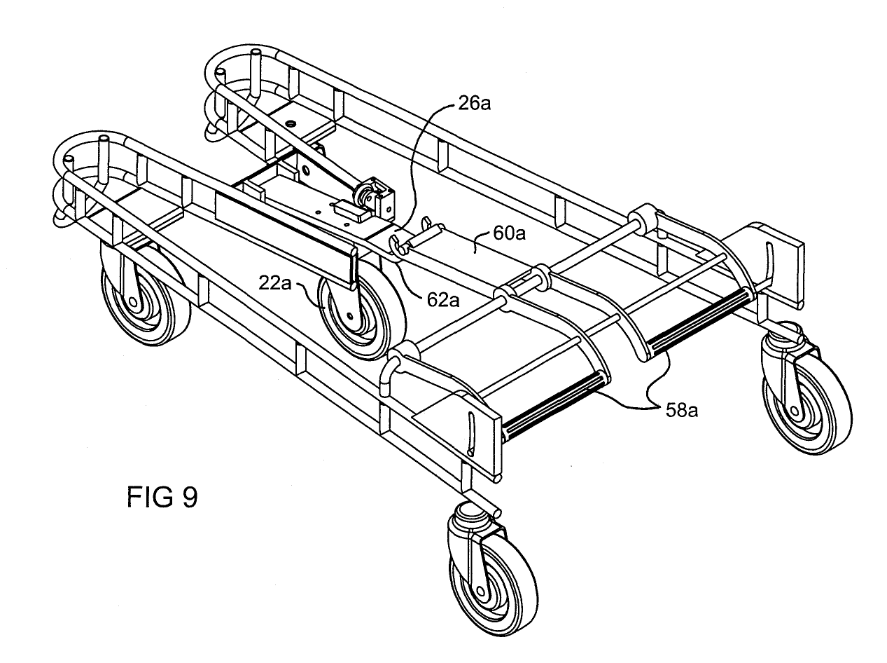

FIG. 9 is a perspective view of a portion of a trolley in accordance with a second embodiment of the present invention, with the direction control wheel in the ground elevance position.

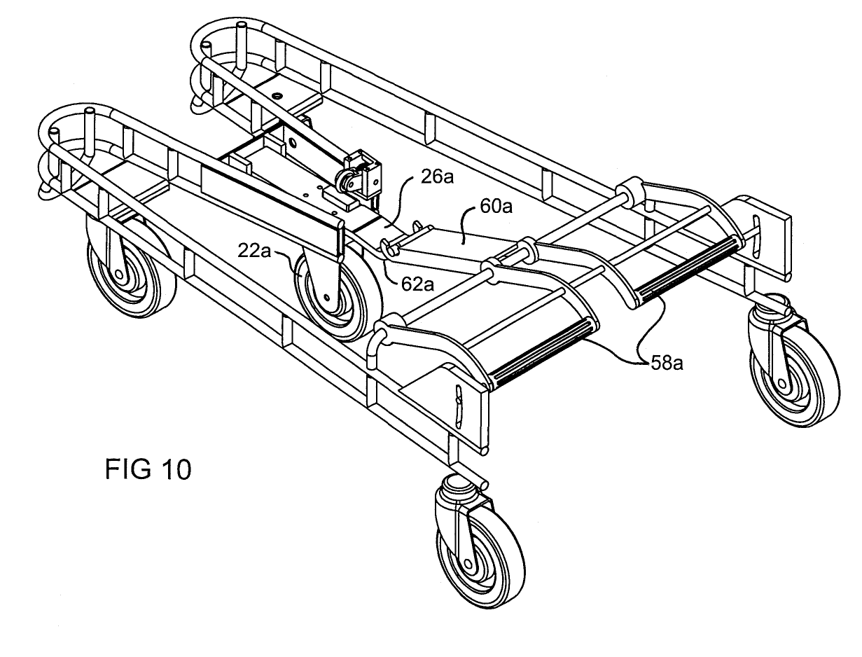

FIG. 10 is a perspective view of the trolley portion illustrated in FIG. 9, with the direction control wheel in the ground contact position.

Referring to FIGS. 1 to 3, there is illustrated a trolley 10. The trolley 10 is a supermarket-type trolley, but may adopt any other practical trolley form.

The trolley 10 includes a trolley frame 12. The illustrated frame 12 is manufactured from steel; although any other suitable material may be used including, for example, plastic.

The trolley 10 includes four wheels 14,16,18,20, each mounted to the frame 12 via a castor mount. The wheels 14,16,18,20 are provided for supporting the frame 12 thereon. The wheels 14,16,18,20 are castor wheels, although it is to be appreciated that each of the wheels may adopt any other suitable form.

The trolley 10 further includes a direction control wheel 22. The direction control wheel 22 is connected to the frame 12 and is displaceable relative to the frame 12 between a ground contact position, as illustrated in FIG. 1; a ground clearance position, as illustrated in FIG. 2; and an obstacle negotiating position, as illustrated in FIG. 3.

The direction control wheel 22 is provided for controlling the direction of travel of the trolley 10 when the wheel 22 is in the ground contact position. The direction control wheel 22 is operably movable between the ground contact position and the ground clearance position, and independently movable between the ground contact position and the obstacle negotiating position. Further, the direction control wheel 22 is independently movable between the ground clearance position and the obstacle negotiating position.

It is to be appreciated that the ground clearance position and the obstacle negotiating position may, in one form, be the same position, such as the position illustrated in FIG. 3 and identified as the obstacle negotiating position.

Indeed, the direction control wheel 22 is independently movable relative to the frame 12 between the ground contact position and a range of obstacle negotiating positions; and likewise between the ground clearance position and a range of obstacle negotiating positions. This enables the direction control wheel 22, within practical limits, to negotiate obstacles having a range of dimensions.

The trolley 10 is configured to provide a trolley user (not illustrated) with the option of using the trolley 10 with the direction control wheel 22 in an active (or ground contact position) or in an inactive (ground clearance position). With the direction control wheel 22 in the ground contact position the wheel 22 guides the trolley 10 in a desired, straight-ahead (and corresponding reverse) direction of travel. However, with the direction control wheel 22 in the ground clearance position the wheel 22 exerts substantially no influence over the direction of travel of the trolley 10, such that in many respects it operates as a conventional trolley.

It is to be appreciated that the orientation of the direction control wheel 22 is fixed relative to the frame 12 such that contact of the wheel 22 with the ground directs any movement of the trolley 10 in a pre-defined, forward (or reverse) direction.

The provision of a selectively operable direction control wheel 22 is potentially very useful in respect of supermarket trolleys, which have a tendency to wander from their desired direction of travel because of damaged or poorly maintained castor wheels. Moreover, such an arrangement would potentially assist a trolley user when pushing a laden trolley 10 to their vehicle, particularly when this entails pushing the trolley 10 across an uneven and/or sloping surface.

Trolley users are presented with particular difficulty when attempting to traverse a slope with conventional trolleys, as the weight of the trolley and its load tends to drag the trolley down the slope due to the effects of gravity. However, with the direction control wheel 22 in the active, ground contact position the trolley 10 resists the tendency to 10 roll down the slope, thereby allowing the shopper to relatively easily traverse the slope with the trolley 10. In this respect, the control wheel is capable of moving out of the way when it meets an obstacle, allowing the remaining wheels to stay on the ground such that the trolley stability is maintained. It is to be appreciated that the direction control wheel preferably rises to an obstacle negotiating position when a predefined upward force is applied to it, such as when it contacts an obstacle.

One particularly useful feature of the trolley 10 is provision of the direction control wheel 22 being independently movable to an obstacle negotiating position. Such an arrangement allows the direction control wheel 22 to independently negotiate a range of obstacles that may be encountered. Further, such an arrangement may be configured to provide improved trolley stability in situations where one or more of the trolley wheels 14,16,18,20 leave the ground, for example when the trolley 10 is being pushed over a roadway gutter or kerb.

It is to be appreciated that the wheel 22 returns from the obstacle negotiating position to either of the ground contact and ground clearance positions under the combined weight of the wheel 22 and arm 26.

Referring particularly to FIGS. 4a, 4b and 5, the direction control wheel 22 is rotatable about a control wheel axle 24 (indicated in a dashed line format), with the control wheel axle 24 being rigidly connected to a generally longitudinally extending wheel arm 26 by a mount 28. The control wheel axle 24 extends in an axial direction orientated generally tangentially relative to the generally longitudinally extending wheel arm 26.

The arm 26 extends in a generally fore and aft direction relative to the trolley 10, having a front or forward end 30 and a rear end 32.

The direction control wheel 22 is displaceable in a substantially vertical plane 34 (see FIG. 5) between each of the ground contact position, ground clearance position, and obstacle negotiating position. The direction control wheel 22 may of course be displaceable in any other plane or indeed may be displaceable along a non-linear path between one or more of the ground contact position, ground clearance position and obstacle negotiating position.

The wheel arm 26 is independently pivotable relative to the frame 12 about a first pivot axis 36 for moving the direction control wheel 22 between the ground contact position and obstacle negotiating position; and between the ground clearance position and the obstacle negotiating position.

The wheel arm 26 is also operably pivotable relative to the frame 12 about the first pivot axis 36 (see FIGS. 4a and 4b) for moving the direction control wheel 22 between the ground contact position and ground clearance position.

The direction control wheel 22 is connected to the arm 26 generally rearwardly of the first pivot axis 36.

The wheel arm 26 is independently pivotable relative to the frame 12 about a first pivot axle 40 pivotably connected to the frame 12 and substantially co-axial with the first pivot axis 36.

The trolley 10 includes a biasing means 42. Although not clearly illustrated, the biasing means 42 includes a torsion spring 44 (not clearly visible) mounted within a housing 46 to the frame 12. The biasing means 42 is provided for biasing the arm 26 in a downward direction when the direction control wheel 22 is in the ground contact position and when in the ground clearance position. This assists in returning the wheel 22 from the ground clearance position to the ground contact position; and also helps to maintain contact of the wheel 22 with the ground when in the ground contact position.

The biasing means 42 includes a deactivating mechanism for deactivating the downward bias of the biasing means 42 on the arm 26 when the direction control wheel 22 is in the obstacle negotiating position.

The deactivating mechanism includes a cam 46 having a cam wheel 48 rotatably mounted thereon. The cam 46 is pivotally mounted to the frame 12, with the torsion spring 44 (not clearly visible) biasing the cam 46 (or more particularly, cam wheel 48) into contact with a generally upwardly facing arm surface 50 when the direction control wheel is in the ground contact position and when in the ground clearance position. Further, the torsion spring 44 biases the cam 46 into contact with a generally side arm surface 52 (not clearly illustrated) when the direction control wheel 22 is in the obstacle negotiating position.

The arm 26 includes a rear end portion 54 angled relative to the longitudinally extending arm 26 to facilitate nesting of the trolley 10 with another trolley or trolleys (as illustrated in FIG. 8).

A mounting point (not illustrated) for mounting a weight (again, not illustrated) may be provided at or proximate the rear end portion 54, to further assist the control wheel 22 returning from the obstacle negotiating position to either of the ground contact or ground clearance positions. A weight in the order of 4 kg is contemplated, although a greater or lesser weight could be attached to the arm 26 if desired. The weight may also assist in returning the wheel 22 from the ground clearance position to the ground contact position.

The trolley 10 includes a trolley handle 56 with a manually operated actuator 58 mounted to the handle 56. The actuator 58 is provided to enable the trolley user to move the direction control wheel 22 from the ground contact position to the ground clearance position. It is to be appreciated that the biasing means 42 and weight of the arm 26 and wheel 22 assist in returning the wheel to the ground contact position.

A biasing member 59 is pivotably mounted (via a bracket 70) to the frame by pivot axle 65. The biasing member 59 has an arm contact portion 66 for contact with the underside of side arm 67. the side arm 67 is integrally formed with the arm 26.

The actuator 58 is rotated from the position illustrated in FIG. 6 to that illustrated in FIG. 7 when moving the wheel 22 from the ground contact position to the ground clearance position.

A cable 60 is connected between the end 68 of biasing member 59 and the actuator 58. The cable 60 is used to move the end 68 of the biasing member 59 vertically, between the positions illustrated in FIGS. 4a and 4b. This action can be seen to also move the arm 26 and, in turn, the wheel 22 between the ground contact position and the ground clearance position. The cable 60 is preferably routed through hollow trolley frame members between the actuator 58 and the wheel arm 26 for aesthetic purposes, and to ensure that the cable 60 is not exposed and therefore prone to damage.

In addition to or in place of the actuator 58 and cable 60 arrangement described above, movement of the direction control wheel 22 between the ground contact position and ground clearance position may be automatically undertaken. Such an arrangement may be desired in situations such as supermarket applications, where it may be preferred that the direction control wheel 22 be automatically moved to the ground contact position when a shopper exits the supermarket with the trolley 10. Automatic movement of the direction control wheel 22 to the ground contact position may be by any suitable means, including an electronic controller provided in or proximate the supermarket, which is in wireless communication with a receiver coupled to the trolley's direction control wheel 22. Indeed, such a controller may independently control the movement of the direction control wheel to the ground contact position for a fleet of trolleys.

It is to be appreciated that the direction control wheel 22 is mounted to the underside of the frame 12 at a location slightly forward of the midpoint of the mounts of each of the castor wheels 14,16,18,20. Indeed, in the illustrated embodiment the direction control wheel 22 is mounted to the frame such that it is proximate the intersection point of imaginary lines drawn between the mounts of diagonally oppositely disposed wheels 14,18 & 16,20. This mounting location has been found to provide a desired level of trolley maneuverability with the direction control wheel 22 in the ground contacting position. Further, this configuration has been found to provide the desired advantage that the trolley 10 can relatively easily rotate about the direction control wheel 22 when mounted in this position and when in contact with the ground. It is to be appreciated, however, that the exact mounting position of the wheel 22 may be altered from the position illustrated.

The trolley 10 includes a foot actuated brake (not clearly illustrated) provided on each of the two rear wheels 18,20. The provision of two wheel brakes in combination with the direction control wheel 22 provides a trolley 10 capable of being left unattended and securely parked, even when left unattended on a sloping surface and irrespective of which direction the trolley 10 may be pointing on the sloping surface.

The frame 12 includes a sub-frame 64 extending around a lower region of the frame 12, with the sub-frame 64 including a portion 66 extending generally rearwardly between the wheels mounts of the two front wheels 14,16, and with the arm 26 pivotably mounted to the sub-frame 64 portion at or proximate the generally rearwardly extending portion 66.

The direction control wheel 22, arm 26 and biasing member 59 are illustrated as being integrated into the trolley 10. However, the direction control wheel 22 and arm 26 may be separately manufactured and subsequently retro-fitted to a trolley, such that they may be fitted to existing trolleys. Further, it is to be appreciated that if the direction control wheel is to be retrofitted then the direction control wheel may be provided in the form of an assembly, including a mount for mounting to a trolley frame.

Another embodiment is illustrated in FIGS. 9 and 10. In this embodiment the manually operated actuator 58a is provided in the form of a pair of foot levers. The foot levers are provided to enable the trolley user to move the direction control wheel 22a from the ground contact position (illustrated in FIG. 10) to the ground clearance position (illustrated in FIG. 9). A linkage 60a is pivotably connected between the wheel arm 26a proximate a forward end 62a of the wheel arm 26a.

Thus, it is to be appreciated that the present invention not only relates to a trolley, per se, but also to a direction control wheel for a trolley.

Finally, it is to be understood that various alterations, modifications and/or additions may be introduced into the construction and arrangement of the parts previously described without departing from the spirit or ambit of this invention.

1. A trolley, comprising:
a trolley frame,
a plurality of wheels mounted to the frame for supporting the trolley thereon, and
a direction control wheel,
the direction control wheel connected to the frame and displaceable relative to the frame between at least three positions, the at least three positions comprising a ground contact position, a ground clearance position and an obstacle negotiating position,
the direction control wheel provided for controlling the direction of travel of the trolley when in the ground contact position,
wherein the direction control wheel is operably movable between the ground contact position and the ground clearance position, independently movable between the ground contact position and the obstacle negotiating position, and independently movable between the ground clearance position and the obstacle negotiating position, and comprising a biasing means for biasing the direction control wheel in a downward direction when the direction control wheel is in the ground contact position and when in the ground clearance position; the biasing means comprising a deactivating mechanism for deactivating the downward bias of the biasing means on the direction control wheel when the direction control wheel is in the obstacle negotiating position.

2. A trolley according to claim 1, wherein the direction control wheel is rotatable about a control wheel axle, the control wheel axle being connected to a generally longitudinally extending wheel arm, and the control wheel axle extending in an axial direction orientated generally tangentially relative to the generally longitudinally extending wheel arm; and.

3. A trolley according to claim 2, wherein the trolley has a front end and a rear end, and the arm extends in a generally fore and aft direction relative to the trolley.

4. A trolley according to claim 1, wherein the direction control wheel is displaceable in a substantially vertical plane between each of the ground contact position, ground clearance position, and obstacle negotiating position.

5. A trolley according to claim 3, wherein:
the wheel arm is independently pivotable relative to the frame about a first pivot axis for moving the direction control wheel between the ground contact position and obstacle negotiating position; and between the ground clearance position and the obstacle negotiating position; and
the wheel arm is operably pivotable relative to the frame about the first pivot axis for moving the direction control wheel between the ground contact position and ground clearance position; and
the direction control wheel is connected to the arm generally rearwardly of the first pivot axis.

6. A trolley according to claim 5 comprising a biasing member pivotably mounted to the frame for biasing the wheel arm, so as to move the direction control wheel from the ground contact position to the ground clearance position.

7. A trolley according to claim 5 wherein the wheel arm is independently pivotable relative to the frame about a first pivot axle pivotably connected to the frame and substantially co-axial with the first pivot axis.

8. A trolley according to claim 1, wherein the biasing means comprises a torsion spring mounted to the frame for biasing the direction control wheel in a downward direction when the direction control wheel is in the ground contact position and when in the ground clearance position.

9. A trolley according to claim 8, wherein the deactivating mechanism comprises a cam pivotally mounted to the frame, the torsion spring biasing the cam into contact with a generally upwardly facing arm surface when the direction control wheel is in the ground contact position and when in the ground clearance position; and biasing the cam into contact with a generally side arm surface when the direction control wheel is in the obstacle negotiating position.

10. A trolley according to claim 2, wherein the arm comprises a rear end portion angled relative to the longitudinally extending arm to facilitate nesting of the trolley with another trolley.

11. A trolley according to claim 1, further comprising a brake provided on at least one of the plurality of wheels.

12. A trolley according to claim 1, further comprising two front wheels and two rear wheels, and a brake provided on each of the two rear wheels, wherein each brake is a foot actuated brake.

13. A trolley according to claim 5, further comprising a manually operated actuator for moving the biasing member to move the direction control wheel between the ground contact position and ground clearance position, the trolley comprising a trolley handle, with the actuator mounted to or proximate the trolley handle, and comprising a cable connected between the biasing member and the actuator; and wherein the cable is connected proximate a forward end of the biasing member.

14. A trolley according to claim 13, wherein the actuator is pivotably mounted to the frame and is in the form of a foot actuator.

15. A trolley according to claim 13, further comprising a linkage connected between the wheel arm and the actuator.

16. A trolley according to claim 1, further comprising four wheels, with each wheel comprising a wheel mount mounted to or proximate the underside of the frame, with the direction control wheel mounted to or proximate the underside of the frame at a location generally bounded by the four wheel mounts; and wherein the direction control wheel is mounted to the frame at least proximate the midpoint of the wheel mounts or slightly forward of the midpoint.

17. A trolley according to claim 1, wherein the direction control wheel is independently movable relative to the frame between the ground contact position and a range of obstacle negotiating positions; and between the ground clearance position and a range of obstacle negotiating positions.

18. A trolley according to claim 16, wherein the frame comprises a sub-frame extending around a lower region of the frame, the sub-frame comprising a portion extending generally rearwardly between the wheels mounts of the two front wheels, and wherein the arm is pivotably mounted to the sub-frame portion at or proximate the generally rearwardly extending portion.

19. A trolley according to claim 1, wherein the ground clearance position and obstacle negotiating position correspond to substantially the same position.

20. direction control wheel for a trolley having a trolley frame and a plurality of wheels mounted to the frame for supporting the trolley thereon, the direction control wheel, when connected to the frame, being displaceable relative to the frame between at least three positions, the at least three positions comprising a ground contact position, a ground clearance position and an obstacle negotiating position, the direction control wheel provided for controlling the direction of travel of the trolley when in the ground contact position, wherein the direction control wheel is operably movable between the ground contact position and ground clearance position, independently movable between the ground contact position and the obstacle negotiating position, and independently movable between the ground clearance position and the obstacle negotiating position, and comprising a biasing means for biasing the direction control wheel in a downward direction when the direction control wheel is in the ground contact position and when in the ground clearance position; the biasing means comprising a deactivating mechanism for deactivating the downward bias of the biasing means on the direction control wheel when the direction control wheel is in the obstacle negotiating position.

21-32. (canceled)
